(19) United States
(12) Patent Application Publication
(10) Pub. No.: US 2010/0100488 A1
(43) Pub. Date: Apr. 22, 2010

(54) INFRASTRUCTURE COMMODITY SAVINGS ACCOUNT

(75) Inventors: Mincheol Kim, Tustin, CA (US); Seung Jin Kim, Tustin, CA (US)

Correspondence Address: Crevent, Inc., 246 Robinson Dr., Tustin, CA, 92782, US

(73) Assignee: CREVENT, INC., Tustin, CA (US)

(21) Appl. No.: 12/579,421

(22) Filed: Oct. 15, 2009

Related U.S. Application Data
(60) Provisional application No. 61/105,882, filed on Oct. 16, 2008.
(60) Provisional application No. 61/161,021, filed on Mar. 17, 2009.

(51) Int. Cl. G06Q 50/00; G06Q 30/00

(52) U.S. Cl. 705/80; 705/26

(57) ABSTRACT

Disclosed is a method and system for an infrastructure commodity savings account program in the context of supplying an infrastructure commodity to a plurality of designated premises for consumption. The method includes receiving a purchase request from a customer for purchasing the infrastructure commodity for future use and selling a quantity of the infrastructure commodity to the customer at a first time with a condition that the infrastructure commodity will not be supplied for consumption for a period from the sale. The method further includes saving the sold quantity of the infrastructure commodity in an infrastructure commodity savings account of the customer; receiving a withdrawal request for withdrawal of the infrastructure commodity from the infrastructure commodity savings account; and processing withdrawal of the infrastructure commodity from the infrastructure commodity savings account at a second time. In the system and method, at least one of receiving the purchase request, selling a quantity, saving the sold quantity, receiving withdrawal request and processing is performed by one or more computing device comprising a processor and a memory.

### RELATED APPLICATIONS

This application claims the benefit of earlier filing dates of U.S. Provisional Patent Application Nos. 61/105,882, filed Oct. 16, 2008, and 61/161,021, filed Mar. 17, 2009. The disclosure of the provisional applications are hereby incorporates herein in their entirety.

### BACKGROUND

1. Field

The present disclosure relates to serviced commodities or infrastructure commodities.

2. Discussion of Related Technology

Water, electricity and gas are supplied to residences and businesses. Typically each residence or business has one or more accounts for subscribing services for these commodities. Residences and businesses use or consume these commodities in their premises such as homes, offices, buildings, factories, etc. The use or consumption constitutes purchases of these commodities and is charged to the accounts typically every month.

### SUMMARY

One aspect of the invention provides a method of running an infrastructure savings program in the context of supplying an infrastructure commodity. The method comprises: supplying an infrastructure commodity to a plurality of designated premises for consumption; receiving a purchase request from a customer for purchasing the infrastructure commodity for future use; in response to the purchase request, SELLING a quantity of the infrastructure commodity to the customer at a first time with a condition that the infrastructure commodity will not be supplied for consumption for a period from the sale; saving the sold quantity of the infrastructure commodity in an infrastructure commodity savings account of the customer; receiving a withdrawal request for withdrawal of the infrastructure commodity from the infrastructure commodity savings account; and in response to the withdrawal request for withdrawal, processing withdrawal of the infrastructure commodity from the infrastructure commodity savings account at a second time. Here at least one of receiving the purchase request, selling a quantity, saving the sold quantity, receiving withdrawal request and processing is performed by one or more computing device comprising a processor and a memory.

In the foregoing method, processing may comprise deducting a requested quantity of the infrastructure commodity from the infrastructure commodity savings account. Processing may comprise supplying the requested quantity of the infrastructure commodity for consumption to a premise designated by the customer. Processing may comprise providing compensation calculated based on the requested quantity to the customer and a predetermined rate of the infrastructure commodity at the second time. Processing may comprise determining whether the period has passed from saving of the infrastructure commodity in the infrastructure commodity savings account. Processing may comprise supplying the requested quantity of the infrastructure commodity for consumption to a premise designated by the customer.

The method may further comprise: opening the infrastructure commodity savings account for the customer, wherein the infrastructure commodity savings account is designed to save a purchased quantity of the commodity for withdrawal at a future time. The infrastructure commodity may be sold at a rate that is at or about a rate of the infrastructure commodity supplied for consumption at the first time. The infrastructure commodity may be sold at a rate substantially different from that of the infrastructure commodity supplied for consumption at the first time. The infrastructure commodity may be sold at a rate that is calculated using a predicted price of the infrastructure commodity at a future time when the period has passed. The period is selected from the group consisting of, 1, 2, 3, 4, 5, 6, 7, 8, 9, 10, 11, 12, 13, 14, 15, 16, 17, 18, 19, 20 and 21 years. The infrastructure commodity is selected from the group consisting of electricity, water or gas. Saving may comprise updating a record of the infrastructure savings account in light of selling of the infrastructure commodity.

### DETAILED DESCRIPTION OF EMBODIMENTS

Various embodiments are described in detail. In the following description, numerous specific details, such as, for example, particular processes, materials, devices, parameters, conditions, structures and so forth, are presented to provide a thorough understanding of embodiments of the invention. One skilled in the relevant art will recognize, however, that the embodiments may be practiced without one or more of the specific details, or with other methods, components, etc. In other instances, structures or operations are not shown or described in detail to avoid obscuring the understanding of embodiments of the invention.

Throughout the disclosure, reference to “an embodiment” or “embodiments” means that a particular feature, structure, process, step, function, parameter, or characteristic described in connection with the embodiment(s) is included in at least one embodiment of the present invention. The phrases “in one embodiment” or “in embodiments” throughout this disclosure does not necessarily mean that the phrases all refer to the same embodiment(s). The particular feature, structure, process, step, function, parameter, or characteristic may be combined in any suitable manner in one or more embodiments.

### Infrastructure/Serviced Commodities

In the present disclosure, the terms “infrastructure commodities” and “serviced commodities” refer to commodities that are supplied or serviced to residential or business premises via infrastructures that are built or provided for servicing or supplying of such commodities. Infrastructure or serviced commodities include water, electricity and gas, although not limited thereto. For water, the infrastructure includes a network of water pipes and conduits that are connected to residences and businesses. For electricity, the infrastructure includes a network of electricity transmission wires that are connected to residences and businesses. For gas, the infrastructure includes a network of gas pipes and conduits that are connected to residences and businesses.

### Commodity Subscription Account

Typically, infrastructure commodities are supplied to businesses and residences on a subscription basis or under a subscription service contract. These serviced commodities are almost necessary or essential in modern life and business operation although some infrastructure commodities may be more common than others. Thus, almost every residence or business has a service subscription account for each of these infrastructure commodities. In situations where more than one residence or businesses are in a single building or address, however, a service subscription account may be established for the single building or address as opposed to each individual residence or business.

These infrastructure commodities are supplied and distributed by companies or government agencies. Accordingly, a service subscription account is created and maintained at or with the company or government agency which supplies or distributes the infrastructure commodity. For example, electricity subscription accounts are maintained at or with electricity companies; water subscription accounts are maintained at or with water service companies or local water authorities such as water districts; and gas subscription accounts are maintained at or with gas companies.

### Infrastructure Commodity Savings Account

In this disclosure, an infrastructure commodity savings account (for short “savings account”) is an account in which to save one or more infrastructure commodities for future use. In embodiments, infrastructure commodity savings accounts include water savings accounts, electricity savings accounts and gas savings accounts. In embodiments, a savings account is created and maintained under an agreement or premise that the infrastructure commodity saved in the savings account can be redeemed or withdrawn from the account at a future time. Thus, a holder of savings account will have right to redeem or withdraw part or all of infrastructure commodity saved in the savings account at a future time. In embodiments, infrastructure commodity servicing companies, government agencies, relevant authorities or third party entities guarantee and ensure redemption of the rights in the savings account or compensation equivalent to the value of infrastructure commodity at a future time when redemption or withdrawal is requested.

### Electronic Management System

The companies and/or authorities running the program of infrastructure commodity savings account maintain an electronic management system to conduct various processes and transactions relating to the savings account. The electronic management system has one or more computers or computing devices, each including at least one processor and at least one memory. In embodiments, two or more computing devices are networked with each other. At least part of these computing devices is connected to the Internet and/or other networks for transactions relating to infrastructure commodities.

As further discussed below, in embodiments, the electronic management system includes at least one of an account opening module, a sales offering module, a purchase transaction module, a pricing module, a saving module, a withdrawal transaction module, an interest module, a consortium module, an assignment module, a trading module. In some embodiments, some or all of these modules are software modules. In other embodiments, some or all these modules are implemented in hardware. In some embodiments, two or more modules may be combined. In other embodiments, some modules may include one or more sub-modules.

### Maturity of Infrastructure Commodity Saved in Savings Account

In embodiments, infrastructure commodities that are purchased and saved in savings accounts may not be withdrawn from the accounts until they are mature. In some embodiments, the maturity is in some time from the purchase or a time set for calculation of the maturity. For example, maturity can be in 1, 2, 3, 4, 5, 6, 7, 8, 9, 10 or 11 months from the purchase. Further, for example, maturity can be in 1, 2, 3, 4, 5, 6, 7, 8, 9, 10, 11, 12, 13, 14, 15 16, 17, 18, 19 or 20 years from the purchase. In some embodiments, the period is predetermined or negotiated at the time of purchase. In one embodiment, the whole account can be mature at a future time when a predetermined period has passed from opening the savings account, from the initial purchase, or from the last purchase. In other embodiments, the maturity is specific to each purchase of infrastructure commodity, and therefore those purchased at different times become mature at different times although they are kept in a single infrastructure commodity savings account.

### Creating Commodity Savings Account

In embodiments, anyone (business or residence) having an infrastructure commodity subscription account (for short “subscription account”) can create or open a savings account to save the infrastructure commodity for future use. In embodiments, the savings account is created as a sub-account of the subscription account. In other embodiments, the savings account is created separate from the subscription account while it may be linked to the subscription account. In some embodiments, opening a savings account may be allowed only to holders of a corresponding infrastructure commodity subscription account. In other embodiments, anyone can open or create a savings account whether or not they own a corresponding subscription account.

In some embodiments, a savings account is for only a single infrastructure commodity. Thus, a person or business may hold more than one infrastructure commodity savings account, including a water savings account for water, an electricity savings account for electricity, a gas savings account for gas, etc. In other embodiments, a savings account can be created for saving more than one infrastructure commodities therein. In one embodiment, the savings account for saving multiple infrastructure commodities may be linked to subscription accounts of corresponding infrastructure commodities.

In one embodiment, the electronic management system may include an account opening module. This module may include one or more computing devices and/or software for the process of opening an infrastructure commodity savings account. In embodiments, the account opening module is configured to process at least part of the features relating to opening an infrastructure commodity savings account discussed in the foregoing paragraphs.

### Offers for Sale of Infrastructure Commodities

According to embodiments, infrastructure commodities are offered for purchase and saving in savings accounts. In some embodiments, offers are made by the company or authority that services or supplies infrastructure commodity. In some embodiments, offers can be made by entities holding infrastructure commodity futures, including by savings account holders. In embodiments, the offers are made or provided to subscription account holders and savings account holders electronically or via conventional mail. In one embodiment, the offers are included in billing statements and/or reports of subscription accounts or savings accounts. In one embodiment, the offers are published or announced to the public.

In embodiments, each offer includes a unit price of the offered infrastructure commodity. In one embodiment, each offer may include a maturity of the infrastructure commodity offered. In one embodiment, the offer may include an estimated price of the infrastructure commodity at the time of maturity. In one embodiment, the offer may include a projection of price of the infrastructure commodity through or to the maturity. In one embodiment, the offers may include an available quantity of their offerings. In one embodiment, the offers may include a purchase limit per account.

In embodiments, the electronic management system may include a sales offering module. This module may include one or more computing devices and/or software for the process of creating infrastructure commodity sales offers. In embodiments, the sales offering module is configured to process at least part of the features relating to sales offers discussed in the foregoing paragraphs.

### Purchasing Infrastructure Commodities

According to embodiments, people and businesses having a savings account can purchase infrastructure commodities and save the purchased commodities in their savings accounts. Purchases of commodities can be made in quantities of the individual infrastructure commodities or in a dollar amount. For example, water can be purchased in volume or weight; electricity can be purchased in wattage; and gas can be purchased in volume or weight, although not limited thereto. Saving of the purchased commodities can be made in the purchased quantities or in another unit for quantifying the infrastructure commodities.

In embodiments, purchases can be made sporadically or periodically. In one embodiment, periodic purchases are made under a periodic purchase arrangement. For example, an arrangement can be made for monthly, bi-monthly, quarterly, bi-annual or annual purchases. In such arrangements, purchase quantity of infrastructure commodity or purchase dollar amount may be fixed at each purchase. Alternatively, in certain arrangement, the infrastructure commodity quantity or dollar amount for a single purchase can vary over time. In one embodiment, a purchase of infrastructure commodity may include more than one maturity. For example, part of a single purchase matures for withdrawal in 5 years, and part of the same purchase matures for withdrawal in 10 years.

In some embodiment where an infrastructure commodity savings account is associated with a subscription account of the infrastructure commodity, a quantity of a purchase can be defined in relation to consumption of the infrastructure commodity of the account holder. For example, x % of one month's consumption or its dollar amount equivalent can be purchased. In one embodiment, the purchase of a predetermined quantity or a quantity determined based on a formula can be repeated as the account holder designates, such as every month, every quarter, every 6 months, every 1 year or every 2 year.

In embodiments, the electronic management system may include a purchase transaction module. This module may include one or more computing devices and/or software for the process of purchase transactions at the account holder's request. In embodiments, the purchase transaction module is configured to process at least part of the features relating to purchase transactions discussed in the foregoing paragraphs.

### Pricing of Infrastructure Commodities

According to one embodiment, the infrastructure commodity is offered for purchase and saving at a price offered for consumption at the time of their purchases. In another embodiment, the infrastructure commodity is offered for purchase and saving at a price significantly lower than a predicted or projected price of the commodity at a future time when the account is mature for withdrawal or redemption. In embodiments, the future price at maturity is predicted or projected based on a predetermined formula or based on predetermined factors. In embodiments, an estimated future price at maturity of the offered infrastructure commodity is provided. In one embodiment, the infrastructure commodity is offered for purchase and saving at a price that is calculated based on the future price at the time of maturity of the savings account. For example, the purchase price is 10, 20, 30, 40, 50, 60 or 70% of the future price at maturity

In embodiments, the offered prices vary in light of various factors. For example, the factors include at least one of supply of the offered infrastructure commodity at the current time, demand of the offered infrastructure commodity at the current time, supply of the infrastructure commodity futures at the current time, demand of the infrastructure commodity futures at the current time, prediction of supply of the infrastructure commodity at a future time, prediction of demand of the infrastructure commodity at a future time, etc. In one embodiment, the prices vary constantly, every a few or several minutes, hourly, every a few or several hours, daily, every a few or several days, monthly, every a few or several month, or yearly.

In some embodiment, the same infrastructure commodity offered at the same time may have different prices based on various factors. In one embodiment, offers of the same infrastructure commodity having different maturity have different prices. In one embodiment, infrastructure commodity originating from or supplied to certain geographical areas have different prices, given all other conditions are identical. In one embodiment, the same infrastructure commodity may have different quality grading or ratings, which make different pricing possible and appropriate. In one embodiment, the companies and/or authorities running the savings account program publishes prices of infrastructure commodities offered for sale and other relevant information.

In embodiments, the electronic management system may include a pricing module. This module may include one or more computing devices and/or software for creating pricing schemes and prices of offerings. In embodiments, the pricing module is configured to process at least part of the features relating to pricing discussed in the foregoing paragraphs.

### Saving of Infrastructure Commodities

According to embodiments, the purchased infrastructure commodities are saved in infrastructure commodity savings accounts. In embodiments, saving of the purchased infrastructure commodities does not involve physically storing the purchased quantity of infrastructure commodity for future use therefrom. Rather in embodiments, saving of the purchased infrastructure commodities involves maintaining and updating records of the purchased quantities of the infrastructure commodities.

In embodiments, the electronic management system may include a saving module. This module may include one or more computing devices and/or software for maintaining and updating records of the purchased quantities. In embodiments, the pricing module is configured to process at least part of the features relating to pricing discussed in the foregoing paragraphs.

### Withdrawal and Use of Saved Infrastructure Commodities

According to embodiments, infrastructure commodities that are mature can be withdrawn from their savings accounts for use or consumption. In one embodiment, a mature quantity of infrastructure commodity is used by the account holder. In other embodiments, a mature quantity of infrastructure commodity can be used by a residence or business that the account holder designates. In one embodiment, the use or consumption at or after maturity may be at no charge. In another embodiment, the use or consumption may incur some service charges other than the consumption of the infrastructure commodity. In embodiments, the service charges may be substantially lower than the then prices of the commodities.

In some embodiments, use or consumption of the saved commodities prior to maturity can be allowed. In one embodiment, however, the use or consumption before maturity may require a penalty or surcharge. In one embodiment, the penalty or surcharge may be exempted when certain requirements are satisfied. In one embodiment, where there is an already mature quantity, the mature one needs to be consumed first before use of any premature quantity of the infrastructure commodity.

In embodiments, the electronic management system may include a withdrawal transaction module. This module may include one or more computing devices and/or software for the process of withdrawal and consumption of saved infrastructure commodity at the account holder's request. In embodiments, the withdrawal transaction module is configured to process at least part of the features relating to withdrawal and consumption discussed in the foregoing paragraphs.

### Interests for Maintaining Commodities in Savings Accounts

In one embodiment, no interest is offered for keeping infrastructure commodities in their savings accounts. In some embodiments, savings accounts are interest bearing, and some interests are offered for keeping infrastructure commodities in their savings accounts. In one embodiment, interest rates or interests differ from commodities to commodities. In one embodiment, interest rates or interests differ based on maturity. For example, the longer the maturity, the higher the interest rates. In one embodiment, interests are offered only for selected periods of keeping infrastructure commodities in their savings accounts. In one embodiment, interests are offered only for commodities that have been kept in their savings account beyond their maturity. In one embodiment, interests are offered throughout the period of maintaining commodities in their savings accounts. In one embodiment, interests or interest rates change over time. In one embodiment, different interests or interest rates apply for blocks of quantities that are in different time spans from their purchase or toward their maturity.

In embodiments, the electronic management system may include an interest module. This module may include one or more computing devices and/or software for generating interest schemes. In embodiments, the interest module is configured to process at least part of the features relating to interests discussed in the foregoing paragraphs.

Raising Money from Sale of Infrastructure Commodities

According to embodiments, infrastructure commodities servicing companies and government agencies can raise money from sales of these infrastructure commodities. Assuming that a lot of subscribers of infrastructure commodities open infrastructure commodities savings accounts and purchase the rights to future use of the infrastructure commodities, a large fund can be built even if individual purchases are in small quantities.

According to embodiments, the money raised from sales of an infrastructure commodity is used to fund activities resolving issues and concerns relating to other infrastructure commodities, and more specifically to fund activities resolving issues and concerns relating to the particular infrastructure commodity. For example, money from sales of water for water savings account is used for addressing or overcoming future water deficiency or other problems relating to water such as water contamination. In some embodiments where the account holders are not allowed to withdraw the saved infrastructure commodities until after a predetermined period of time, e.g., 10 years from the purchase, the revenue from the sale of future water consumption can be intact for 10 years. For example, the money from sale of water can be used to scientific researches for desalination of ocean water, building water pipelines, recycling sewage water, developing underground water, pre-purchasing water from water effluent states or regions, etc.

In embodiments, the electronic management system may include a fund managing module. This module may include one or more computing devices and/or software for managing funds from sales of the infrastructure commodities. In embodiments, the pricing module is configured to process at least part of the features relating to managing funds discussed in the foregoing paragraphs.

### Infrastructure Commodities Consortiums

People and businesses move from one location to another. Moving can result in changes of companies or government agencies servicing or supplying infrastructure commodities. When moving results in a change of infrastructure commodity servicing companies, the infrastructure commodity previously saved in an old savings account held with an old entity may not be used or withdrawn through the old entity. To address this problem, in some embodiments, one or more consortiums can be formed by companies and/or government agencies providing infrastructure commodity services in various geographical locations. According to embodiments, these consortiums are to handle transfers of savings between infrastructure commodity savings accounts held with two companies or government agencies.

For example, in case an account holder in Water District A moves to Water District B, the water savings account of the holder is transferred from Water District A to Water District B. Alternatively, at least part of the water saved in the water savings account held with Water District A is transferred to the water savings account held with Water District B. This transfers the obligation to supply water to the account holder in the future from Water District A to Water District B. The consortium can handle and manage transfer of the obligations as well as transfer of the accounts. In one embodiment, a value equivalent to the obligation is transferred under the consortium's coordination or control from Water District A to Water District B. In another embodiment, individual water authorities and companies transfer their obligations and corresponding rights to the consortium with regard to all of the water savings accounts held with them. In this latter embodiment, and there is no need to transfer obligations to account holders from one authority to another when the account holders move.

In embodiments, the electronic management system may include a consortium module. This module may include one or more computing devices and/or software for managing the consortium and its participants. In embodiments, the pricing module is configured to process at least part of the features relating to the consortium discussed in the foregoing paragraphs.

### Assignability of Infrastructure Commodities

In embodiments, a savings account is created and maintained under an agreement or premise that all or part of the infrastructure commodity saved in the savings account can be assigned or transferred. In embodiments, there may be certain restrictions and conditions for the transfer of infrastructure commodities saved in a savings account. In embodiments, holders of infrastructure commodity savings accounts can assign or transfer their rights in their accounts to others. Some of the infrastructure commodities saved in their savings accounts can be assigned or transferred to others. In embodiments, account holders may sell their rights to use infrastructure commodities in the future to other. In embodiments, account holders may exchange their rights in the savings accounts with rights of others. For example, water savings of one person can be exchanged with electricity savings of another person. Also, electricity savings with one company can be exchanged with electricity savings with another company. Also, in embodiments, the savings accounts as a whole can be assigned or transferred to others.

In embodiments, the electronic management system may include an assignment module. This module may include one or more computing devices and/or software for managing assignments of saved infrastructure commodities and/or savings accounts. In embodiments, the pricing module is configured to process at least part of the features relating to assignments discussed in the foregoing paragraphs.

### Trading of Infrastructure Commodities

The rights to future use of infrastructure commodities can be traded as infrastructure commodity futures. In embodiments, infrastructure commodities savings, whether matured or not, can be sold or purchased among entities that do not hold a savings account. To facilitate such transactions, infrastructure commodities trading markets or exchanges may be established. Alternatively, existing exchange markets for commodities or financial futures may handle sales transactions of infrastructure commodity futures.

In transactions of rights to future use, infrastructure commodities are sold in their unit quantities. For example, water futures are sold in volume, and electricity futures are sold in wattage. Sales transactions may occur in multiplicity of predetermined unit quantity. In trading, the infrastructure commodity futures or rights to future use of infrastructure commodities are identified with their maturity time or the period remaining to their maturity time. Optionally, infrastructure commodity futures may also be identified with company/authority from which future infrastructure commodity can be withdrawn. Further optionally, infrastructure commodity futures may be identified with locality in which the future infrastructure commodity can be used. Factors that determine transaction prices include one or more of quantity, maturity time, company/authority supplying the infrastructure commodity and locality, etc.

In embodiments, the electronic management system may include a trading module. This module may include one or more computing devices and/or software for managing and tracking trading of saved infrastructure commodities and/or savings accounts. In embodiments, the pricing module is configured to process at least part of the features relating to trading discussed in the foregoing paragraphs.

What is claimed is:

1. A method of running an infrastructure savings program in the context of supplying an infrastructure commodity, the method comprising:
supplying an infrastructure commodity to a plurality of designated premises for consumption;
receiving a purchase request from a customer for purchasing the infrastructure commodity for future use;
in response to the purchase request, selling a quantity of the infrastructure commodity to the customer at a first time with a condition that the infrastructure commodity will not be supplied for consumption for a period from the sale;
saving the sold quantity of the infrastructure commodity in an infrastructure commodity savings account of the customer;
receiving a withdrawal request for withdrawal of the infrastructure commodity from the infrastructure commodity savings account; and
in response to the withdrawal request for withdrawal, processing withdrawal of the infrastructure commodity from the infrastructure commodity savings account at a second time,
wherein at least one of receiving the purchase request, selling a quantity, saving the sold quantity, receiving withdrawal request and processing is performed by one or more computing device comprising a processor and a memory.

2. The method of claim 1, wherein processing comprises deducting a requested quantity of the infrastructure commodity from the infrastructure commodity savings account.

3. The method of claim 1, wherein processing comprises supplying the requested quantity of the infrastructure commodity for consumption to a premise designated by the customer.

4. The method of claim 1, wherein processing comprises providing a compensation calculated based on the requested quantity to the customer and a predetermined rate of the infrastructure commodity at the second time.

5. The method of claim 1, wherein processing comprises determining whether the period has passed from saving of the infrastructure commodity in the infrastructure commodity savings account.

6. The method of claim 1, wherein processing comprises supplying the requested quantity of the infrastructure commodity for consumption to a premise designated by the customer.

7. The method of claim 1, further comprising:
opening the infrastructure commodity savings account for the customer, wherein the infrastructure commodity savings account is designed to save a purchased quantity of the commodity for withdrawal at a future time.

8. The method of claim 1, wherein the infrastructure commodity is sold at a rate that is at or about a rate of the infrastructure commodity supplied for consumption at the first time.

9. The method of claim 1, wherein the infrastructure commodity is sold at a rate substantially different from that of the infrastructure commodity supplied for consumption at the first time.

10. The method of claim 1, wherein the infrastructure commodity is sold at a rate that is calculated using a predicted price of the infrastructure commodity at a future time when the period has expired.

11. The method of claim 1, wherein the period is selected from the group consisting of, 1, 2, 3, 4, 5, 6, 7, 8, 9, 10, 11, 12, 13, 14, 15, 16, 17, 18, 19, 20 and 21 years.

12. The method of claim 1, wherein the infrastructure commodity is selected from the group consisting of electricity, water or gas.

13. The method of claim 1, wherein saving comprises updating a record of the infrastructure savings account in light of selling of the infrastructure commodity.
